(19) United States
(12) Patent Application Publication
(10) Pub. No.: US 2003/0163425 A1
(43) Pub. Date: Aug. 28, 2003

(54) System for executing high-volume electronic bill payments

(76) Inventor: Thomas Calvin Cannon JR., Columbia, MD (US)

Correspondence Address: Thomas Calvin Cannon, Jr., 5165 Phantom Court, Columbia, MD, 21044-1318, US

(21) Appl. No.: 10/082,718

(22) Filed: Feb. 26, 2002

(51) Int. Cl. G06F 17/60

(52) U.S. Cl. 705/42; 705/40; 705/39

(57) ABSTRACT

The present invention is an electronic bill payment system that employs holding accounts, maintained by a collection of banks or a third party, to pay high-volume payees by first making internal funds transfers from payers accounts into holding accounts, and then making funds transfers from holding accounts into the accounts of high-volume payees residing within the same banks.

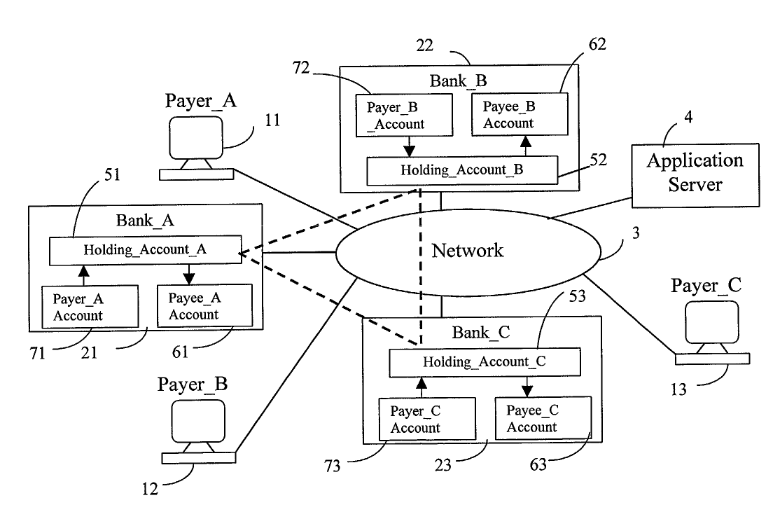

### BACKGROUND OF THE INVENTION

This invention relates to a financial transaction system for efficiently making electronic payments by minimizing external funds transfers through the use of holding accounts to facilitate internal funds transfers from payers accounts into the accounts of high-volume payees.

Bill payment in the United States is dominated by paper checks. Over the years, banks, merchants and the Federal Reserve Board have developed efficient systems for handling massive flows of paper checks—over 60 billion checks per year. However, in this electronic age, customers (payors), merchants (payees) and banks have been seeking more efficient processes that reduce paper flow, speed-up processing, provide all parties with more up-to-date and manageable payment data, and most important, reduce cost. To this end, over the last 15 years banks have been offered their customers various systems for electronically paying bills.

Techniques for electronic bill payment have usually focused on the vehicles of delivering and paying bills. For example, the technique disclosed in U.S. Pat. No. 5,283,829 issued Feb. 1, 1994 to Milton Anderson employs a telephone to issue payment instructions to banks. Other systems have capitalized on the widespread availability of personal computers as input and output devices. The technique disclosed in U.S. Pat. No. 4,823,264 issued Apr. 18, 1989 to Gilbert Deming employs a personal computer to input bill payment information and initiate payments. Going further, the technique disclosed in U.S. Pat. No. 5,699,528 issued Dec. 16, 1997 to Edward Hogan uses electronic machines to both deliver bill images as well as initiate payment of the associated bills.

However, the major issue facing electronic banking is not the interface for presenting and paying bills, but rather low-cost mechanisms for making electronic payments. The major cost components of present day systems are customer service costs and the cost of processing external funds transfers through the National Automated Clearing House Association (NACHA), hereafter referred to as the ACH. The present invention describes a system for minimizing processing costs by minimizing external electronic funds transfers.

All electronic payments are processed through either the Automated Clearing House (ACH) operated by the Federal Reserve Board (Fed) or the similar Remittance Processing System (RPS) operated by MasterCard International. Electronic funds transfers through the ACH began by a Receiver authorizing an Originator to initiate a credit or debit entry to a transaction account held at a Receiving Depository Financial Institution (RDFI). The Originator then forwards transaction data to the Originating Depository Financial Institution (ODFI). The ODFI sorts and transmits the transaction file to the ACH Operator. The ACH Operator then distributes an ACH file to the RDFI. Finally, the RDFI makes funds available to the Receiver and provides the Receiver with a statement of the transaction.

In the absence of errors or inquiries by either customers or merchants, the ACH process appears to be efficient and cost-effective. Funds are transferred overnight at current-day rates of $0.015 per transaction, charged to both the originating and receiving banks (for a total of $0.03 per transaction). However the process has several weaknesses. Insufficient funds or incorrect account information, result in both added costs and delays. The Fed typically charges $18.00 for transactions that can't be processed, and it typically takes 10 days before ACH reversals are returned to the initiating bank for reconciliation with the customer's account. To avoid such costs and delays, banks invest considerably in up-front processes to eliminate errors. Despite such efforts, banks and payment application servers have yet to eliminate costly customer service organizations to resolve errors and inquiries.

Since ACH and RPS transaction do not trigger responses from the receiving bank (merchant), it is impossible for the customer to know if and when a payment was posted. This failure to reach closure results in customer service inquiries thereby adding cost to the process. Including all of the fixed and variable costs, the actual average cost of a current day electronic bill payment approximates $0.80 per transaction. This compares unfavorably to costs for customers paying directly by check ($0.34+for postage, etc.) Banks find the high cost per payment unacceptable. This is why banks offering bill payment do not aggressively market the service to their customers unless they are charging a prohibitively high cost for the service. Otherwise, when banks do offer electronic bill payment, these costs are ultimately absorbed either in the form of a direct charge, or imbedded in the price of other bank services.

Conventional electronic bill payment systems, such as the ones operated by CheckFree, and other service bureaus, typically involve two simultaneous ACH transactions. The process begins by the end-user (i.e. payer) issuing a request to make an electronic payment to a payee. The end-user typically originates such requests over a voice or data network to either an Internet-based on telephone-based payment input facility maintained by a application server. Once the application server receives the payment request, it debits the end-user's account residing in the end-user's bank and credits the service bureau's account residing in the service bureau's bank through an ACH transfer. At the same time, the service bureau processes a separate transaction through the ACH, debiting the service bureau's account and crediting the payee's account residing in the payee's bank for the amount of the payment. The obvious weakness of executing two separate and simultaneous ACH transactions is that problems on either end will result in a faulty transaction. This, in turn, will necessitate manual intervention on behalf of the service bureau, the ACH, the banks involved, and perhaps the payee, resulting in high average overhead cost per transaction.

The present invention minimizes the propagation of faulty external electronic transactions by minimizing the number of external transactions that must be processed. This not only reduces processing costs but also has a secondary effect of reducing end-user service costs by minimizing end-user inquiries.

### BRIEF SUMMARY OF THE INVENTION

The present invention is an electronic bill payment system that employs holding accounts, maintained by a third party such as a bank or a service bureau, to pay high-volume payees by making internal funds transfers from the holding accounts to the high-volume payee accounts residing at the same banks as the holding accounts. The service bureau sets up holding accounts at the banks in which high-volume payees maintain their accounts. Arrangements are made with each bank to allow internal funds transfers from the holding account residing in each bank into the accounts of the resident high-volume payees. Such high-volume payees include, for example, utilities, telephone service providers, credit card companies, mortgage companies, and major department stores. End-users who subscribe to an electronic bill payment service with a particular bank may pay their bill to a high-volume payee who also maintains an account at the same bank by means of an internal funds transfer within the bank. Such internal funds transfers are facilitated by a service bureau who first debits the end-users' account and credits the service bureau's Holding Account at the bank. The transaction is completed by then transferring funds from the service bureau's Holding Account to the high-volume payee's account within the bank.

Using this same process, a payer may make electronic payments to high-volume payees who maintain accounts at banks other than the payer's home bank, provided that all banks are supported by the same service bureau. A payer who maintains an account at a bank other than that of a particular high-volume payee is referred to as an external payer. In this scenario, an external payer may make a payment to a high-volume payee by simply ordering the service bureau to make a payment from the local holding account to the high-volume payee's account at the same bank. Just prior to making such a payment, the service bureau would debit the external payer's account and credit the local holding account at the external payer's bank.

Settlement between the holding accounts located at various banks takes place at the end of the transaction day. Such settlement involves a series of electronic funds transfers (EFT) between the various holding accounts. If there are N distinct holding accounts, then N−1 separate transfers would be sufficient to settle all holding accounts. For example, one settlement routine consists of first transferring all the excess funds from those holding accounts having excess deposits into the one holding account having the largest deficit. The second and final step is to transfer excess funds from the holding account that formerly had the largest deficit into the remaining holding accounts that have deficits.

Payments to non-high-volume payees may be made through conventional means that are well known within the banking and financial services community. But by eliminating the need to execute external EFTs to high-volume payees, the load of payments executed through the ACH or RPS may be considerably reduced, depending on how many of the high-volume payees are served by the system.

### BRIEF DESCRIPTION OF THE DRAWINGS

The drawing provided is an exemplary embodiment of an electronic bill payment system according to the present invention. It shows, by means of dashed lines, the virtual paths for settlement between the various Holding Accounts 51, 52, and 53.

Throughout the drawing, the same reference numerals and characters, unless otherwise stated, are used to denote like features, elements, components or portions of the illustrated embodiment. Moreover, while the subject invention will now be descried in detail with reference to the drawing provided, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

The drawing is a schematic of an electronic bill payment system according to the present invention. The system consists of a collection of payers, payees, banks, accounts within the banks, and an application server 4 connected by a network 3. Within the scope of the present invention, a network 3, may be replaced by a system of networks interconnecting the various elements of this invention so as to provide greater security or some other benefit to the system. The schematic has been simplified to show just three payers, Payer_A 11, Payer_B 12, and Payer_C 13, even though in practice there will be numerous payers connected to the network 3. Each payer maintains an account within his or her associated bank, Bank_A 21, Bank_B 22, and Bank_C 23, respectively. In general, each bank will host accounts for multiple payers. The accounts corresponding to Payer_A 11, Payer_C 12, and Payer_C 13, are Payer_A Account 71, Payer_B Account 72, and Payer_C Account 73, respectively. Without loss of generality, the schematic has been further simplified to show just three payee accounts, Payee_A Account 61, Payee_B Account 62, and Payee_C Account 63, even though in practice each bank will host multiple payee accounts. Each payee maintains an account within his or her associated bank.

The process for executing payments will be illustrated by describing the sequence of steps for Payer_A 11 to make a payment into Payee_C Account 63. Payer_A 11 begins the payment process by logging onto the application server 4 that resides on a network 3 and issuing a payment request to be made into Payee_C Account 63. In this particular case, Payee_C Account 63 does not reside at Bank_A 21, the bank where Payer_A 11 maintains his or her account. However, the same routine applies regardless of where the payee account resides, as long at it resides at one of Bank_A 21, Bank_B 22, or Bank_C 23. The application server 4 responds to the payment request from Payer_A 11 by ordering funds to be transferred from Payer_A Account 71 into the Holding_Account 51 residing at Bank_A 21. The next step is to retain the payment funds in the service bureau account residing at the payer's bank, Holding_Account 51, until the transaction clears through the settlement process employed by the payer's bank, Bank_A 21. Such settlement processes are usually performed over night. The payment is concluded by the application server 4 ordering a transfer of funds from the service bureau account residing at the payee's bank, Holding_Account 53, into the payee's account, Payee_C Account 63.

At the end of the transaction day, there will generally be an imbalance between the funds transferred into and out of each Holding_Account_A 51, Holding_Account_B 52, and Holding_Account_C 53. However, the sum of the imbalances will be zero and settlement between these service bureau accounts 51, 52, and 53 may be accomplished through a series of external electronic funds transfers (EFT). One such settlement routine consists of first transferring all of the excess funds from those holding accounts having excess funds into the one holding account having the largest deficit, and then transferring funds from the holding account that formerly had the largest deficit into the remaining holding accounts having deficits, in the exact amounts needed to balance each remaining holding account Using this routine, the number of EFTs required to achieve settlement is equal to one less than the number of holding accounts. In the case of 3 holding accounts, 2 separate EFT's would be required to obtain settlement between the three holding accounts.

At the end of the transaction clay, the application server 4 collects, partitions and formats payment date to be sent to the payees. The corresponding payment data is relayed to payers and their banks. This completes the payment cycle.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What I claim as my invention is:

1. A system for processing electronic payments that consists of a bank,
a plurality of payer accounts within the bank,
a plurality of payee accounts within the bank,
a holding account maintained by the bank or a third party, and
a process for transferring funds from payer accounts to payee accounts, all residing within the same bank,
by first transferring an amount equal to the payment from the payer's account into the holding account,
and then transferring an amount equal to the payment from the holding account into the payee's account.

2. A system according to claim 1, further comprising a routine for screening out faulty payment funds transfers from payee accounts into the holding account by
delaying movement of payment funds, for each transaction, out of the holding account until the bank has cleared each payment funds transfer into the holding account through a settlement process at the end of a designated transaction period.

3. A system for processing electronic payments that consists of
a defined collection of barks each of which supports its own internal holding account used to facilitate electronic payments,
a plurality of payers, each of which maintains an account with at least one bank within the defined collection of banks,
a plurality of payees, each of which maintains an account with at least one bank within the defined collection of banks,
an agent, controlled by either the defined collection of banks or a third party, that directs the transfer of payment funds from a payer account into a holding account residing within the same bank as the payee account with the defined collection of banks, and also directs the transfer of payment funds into a payee account from a holding account residing within the same bank as the payee account within the defined collection of banks,
a process for settling funds between the various holding accounts maintained in the defined collection of banks by executing a series of funds transfers between the various holding accounts at the end of a prescribed transaction period.

4. A system according to claim 3, further comprising a routine for screening out faulty payment funds transfers from payee accounts into holding accounts by
delaying movement of payment funds, for each transaction, out of the associated holding account until the bank in which the holding account resides has cleared each payment funds transfer into the holding account through a settlement process at the end of a designated transaction period.

5. A system according to claim 4, in which the settlement routine for balancing funds across the various holding accounts consists of
first transferring all of the excess funds from those holding accounts having excess funds into the one holding account having the largest deficit,
and then transferring funds from the holding account that formerly had the largest deficit into the remaining holding accounts having deficits, in the exact amounts needed to balance each remaining holding account.
